(19) United States
(12) Patent Application Publication
(10) Pub. No.: US 2020/0035038 A1
(43) Pub. Date: Jan. 30, 2020

(54) An Interactive Implementation Method for Mobile Terminal Display of 3D Model

(71) Applicant: CHANGSHA MORALE NETWORK TECHNOLOGY CO., LTD., Hunan (CN)

(72) Inventors: Tao LI, Hunan (CN); Yuxiang XIA, Hunan (CN)

(21) Appl. No.: 16/496,664

(22) PCT Filed: Apr. 21, 2017
(86) PCT No.: PCT/CN2017/081448

§ 371 Date: Sep. 23, 2019

(30) Foreign Application Priority Data
Mar. 24, 2017 (CN) 201710183421.6

(51) Int. Cl. G06T 19/20; G06F 3/0484; H04L 29/06; G06T 5/50

(52) U.S. Cl. CPC G06T 19/20; G06F 3/04842; G06F 3/04845; G06T 2219/2021; G06T 5/50; G06T 2219/2008; G06T 2207/10012; H04L 29/06

(57) ABSTRACT

An interactive implementation method for mobile terminal display of 3D model, comprising the following steps of: 1. acquiring 3D model data from the data center, then optimizing the 3D model for reduction and putting the 3D model into the specified folder; 2. checking if the current environment is correct. If not, setting the environment; 3. importing into different layer areas according to different categories of 3D models; 4. creating a Point Light for each area, and naming the Point Light by which space to enter; 5. conducting material adaptation, generating a normal map for the 3D model and placing normal map in the normal map channel; 6. determining the mapping specification and mapping the 3D model in the import file; 7. importing the model upload background page into U3D, selecting the 3D model to be exported, calling up the corresponding upload option, generating Prefabs file from the 3D model and then uploading. The advantage of the method is the realization of the mobile terminal display of 3D model with simple process and better display effect.

### FIELD OF THE INVENTION

The invention relates to a transmission control procedure and image analysis, in particular to an interactive implementation method for mobile terminal display of 3D model.

### BACKGROUND

With the mobilization of data platforms, a large amount of data is seeking for mobile terminal display, especially for 3D model data. The commonly used 3D model display technology is only applicable to the PC platform, and has certain requirements on the hardware of the device. A good display effect cannot be achieved for a mobile device with insufficient hardware performance. Among the existing technologies, one is the pseudo-3D technology by mapping directly or by compressing the model directly through a third-party engine. Second, all models are specially made. The former scheme produces poor display effect and is laborious, and the production process is cumbersome. In the latter scenario, labor costs are very high.

### SUMMARY OF THE INVENTION

In view of the shortcomings of the prior art, an object of the present invention is to provide an interactive implementation method for mobile terminal display of 3D model. The Unity3D external automation program is used to reduce the surface of the model, optimize the point-surface structure of the model, and put 3D model into the corresponding processing folder according to the category. After the 3D model is imported into the external automation program, the method of the present invention maps the categories according to the file and file name recognition model, assigns materials, lights, modifies the level mask, and packages the mobile to display interactive data.

The technical solution adopted by the present invention to solve the technical problem thereof is to provide a method for implementing a mobile terminal display interaction of a 3D model, which is characterized in that the following steps are included:

I. Acquiring 3D model data from the data center, then optimizing the 3D model for reduction and putting the model category into the designated folder according to the model type;

II. Checking if the current environment is correct. If not correct, setting the environment;

III. Importing into different layer areas according to different categories of 3D models;

IV. Creating a Point Light for each area, and naming the Point Light by which space to enter;

V. Conducting material adaptation, firstly creating a [material library] and loading the [material library] to the project file; the Material in the imported FBX file adapts the shader and related parameters used by the Material with same name in the [material library]. Normal map for the 3D model is generated and put into the normal map channel.

VI. Determining the mapping specification and mapping the 3D model in the import file.

VII. Introducing the model upload background page to U3D, after the model is created, selecting the 3D model to be exported for mapping. opening the upload page and selecting the upload type, calling up all appropriate upload options, generating Prefabs file from the 3D model and then uploading.

The advantage of the method is the realization of the mobile terminal display of 3D model with simple process and better display effect.

### DRAWINGS

The invention will now be described in detail in conjunction with the drawings.

FIG. 1 is a flow chart of the steps of the present invention.

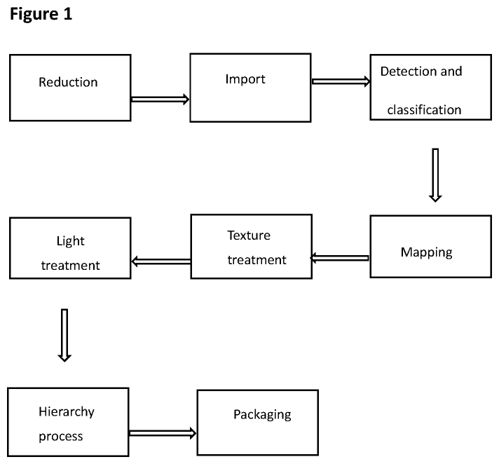

In an embodiment of the present invention: an interactive implementation method for mobile terminal display of 3D model is characterized by the following steps:

I. Acquiring the data of the 3D model from the data center using the Unity3D program, calling PolygonCruncherSDK, using face reduction optimization data to optimize the 3D model. After processing, put the 3D model into the designated folder according to the 3D model category;

II. Enabling Lnity3D to check if the current environment is correct. If not correct, make the following settings;

a. Modifying the default SkyBox to WispySkybox and Ambient Source to Color. Setting the Ambient Color parameter to RGB=5B5B5B, canceling the automatic baking;

b. The Bundle Identifier field in PlayerSettings is automatically set. Modifying Device Filter to ARMv7;

c. Setting Rendering Path to Forward mode;

d. Layers settings:

User Layer 8: Light, User Layer 9: Player, User Layer 10: Floor, User Layer 11: Tianhua, User Layer 12: Baijian, User Layer 20: NGUI, User Layer 21: Cube, User Layer 22: NewModel, User Layer 23: OPC, User Layer 24: door, User Layer 25: MovieTV, User Layer 26: Ditan;

e. Tags settings:

Tag 0: ding, Tag 1: che, Tag 2: pengzhuang, Tag 3: jiaohu, Tag 4: deng, Tag 5: diaodeng, Tag 6: dianti, Tag 7: diantianniu, Tag 8: damen, Tag 9: Terrain, Tag 10: TV;

f. QualitySettings is set to Fantastic and Pixel Light Count is set to 4, Anisotropic Texture is set to Forced On;

III. After importing the space model, putting the group chuang, group men, group chufang, dimian combination Tijiaoxian_meshc in the Light layer; placing the object model in the Player layer (except ditan, diaodeng); Adding a Tag ding for group tianhua and ZGZ_01_noc; selecting Reflection Probe Static option in Static options for all objects;

Changing MaterialNaming to Model Name+Models Material;

IV. Creating a Point Light for each area, 2.2 meters above the ground. Selecting Important option of the Render Mode and Light, Player, baijian, ditan layers of the Culling Mask;

g. Point Light naming: the light source that has an influence on the main space shall be summarized into the main space naming; Such as: kt01-01, kt01-02, kt01-03, kt01-04, kt01-05, kt01-06; zws01-01, zws01-02; cws01-01, cws01-02;

h. Creating a Reflection Probe under the Point Light sublevel of each area and positioning the Reflection Probe to zero; Reflection Probe settings: Type is Realtime; Refresh Mode is Via scripting; Time Slicing is No time slicing; selecting Box Projection;

Size and Probe Origin settings shall be slightly larger than the size of the area in which they are located;

The Resolution under Cubemap Capture settings is 256, and the rest are default;

i. All the child nodes under menzuOO1, menzu002, menzu003, etc. are added with empty objects and named according to which space to enter;

V. Material Adaption, the adapting method of material map for the object model is as follows:

Firstly, creating a [material library] by the shader script and common Material index and loading to project file; the Material in the imported FBX file adapts the shader and related index used by the Material with same name in the [material library] and at the same time maintains the Material's own diffuse reflection color and map and providing option for whether to generating normal map. The normal map will be automatically generated by the diffuse reflection map (generating parameters refer to [mapping specification \5. Normal Mapping]) and will be put into the normal map channel after being generated;

The reference value of the Material parameter in [shader resource file] is as follows:

White latex paint: Use Laobai/CustomLight, the object receives illumination; parameter setting: [Glossity 1]; [Specularity 1]; [Smoothness 1]; [MainColor], [MainTex] and [Normalmap] are selected according to the object; [Select Lightmap Tag]; [LightMap Intensity 1]; [LightColor RGB (125,125,125)]; [LightMap adds corresponding lightmap];

Wood grain (matt): Uses Laobai/Custom Light, the object receives illumination; parameter setting: [Glossity7.6.]; [Specularity 0.76]; [Smoothness 2]; [MainColor RGB160.160.160], [MainTex Wood grain map] and [Normalmap wood grain map-n] are selected according to the object; [Lightmap Tag] is not selected;

Marble (matt): Uses Laobai/Custom Light, the object receives illumination; parameter settings: [Glossity8.]; [Specularity 1.2]; [Smoothness 2]; [MainColor RGB160.160.160], [MainTex Marble Map] and [ Normalmap mosaic map_n] are selected according to the object; [Lightmap Tag] is not selected;

Mirror: The object is first ensured to be Plane, add Planar Realtime Reflections (Scripts) script for the object; then use Realtime Reflections/PlanarReflection, [MainAlpha 0.1]; [ReflectionAlpha1]; [Tint Color (RGB) white RGB value 255.255.255] [MainTex is empty].

Glass: Use Laobai/Refraction, the object receives illumination; parameter settings: Refraction Intensity 0.1];

Leather: Use Laobai/Custom Light, the object receives illumination; parameter setting: [Glossity 4]; [Specularity 1.5]; [Smoothness 0.5]; [MainColor] and [MainTex] are selected according to the object; [Normalmap adds leather Normal map], [Lightmap Tag] is not selected;

Porcelain: Use Laobai/Custom Light, the object receives illumination; parameter setting: [Glossity8.8]; [Specularity 0.65]; [Smoothness 1]; MainColor and MainTex are selected according to the object, [Lightmap Tag] is not selected;

Stainless steel: use Legacy Shader/Reflective/Bmped Diffuse; parameter setting: [Main Color Black]; [Reflection Color White]; [Reflection Cubemap] Add Cubmap created by SkyBoxGenerator.js environment; [Normalmap can choose whether to add according to material requirements (such as brushed stainless steel, etc.), if you add Normalmap, the object must be placed in the Light layer].

Black Titanium: Same as stainless steel, except that the parameter [Reflection Color] is set to dark gray (RGB values are 70, 70, 70)

Cloth pattern: Use Laobai/Custom Light, the object receives illumination; parameter setting: [GlossityO]; [Specularity 0.2]; [Smoothness 2]; [MainColor] and [MainTex] are selected according to the object; [Normalmap adds the cloth normal map], [Lightmap Tag] is not selected;

Fabric 2 (Silk class): Uses Laobai/Custom Light, the object receives illumination; parameter setting: [Glossity 3.2]; [Specularity 1.14]; [Smoothness. 52]; [MainColor] and [MainTex] are selected according to the object; [Normalmap adds silk normal map], [Lightmap Tag] is not selected;

The adapting method of material map for the space model is as follows:

j. after importing the model, the wall space model qiangmian_, tianhua_ will seeking for the light map corresponding to the name of the model by the shader of Legacy Shaders/Lightmapped/Bumped Diffuse and the Texture of Lightmap (RGB). For example, tianhua_01 will find the light map of tianhua_01-Ltga; the RGB value of Main Color is 255.225.225;

k. other material will adapt to the corresponding Material according to the object model method;

VI. Determining the mapping specification and conducting the mapping

A. The size of all the maps shall be adjusted to 128*128, 256*256, 512*512 according to the demanded size, no more than 1024*1024; map of small object shall not be larger thank 256*256, tiled map shall be no larger than 512*512 and large-size map without being tiled shall be no larger than 1024*1024;

B. Size of maps of material in same category or of same specification or exchangeable shall be unified to 512*512.

C. Name of light map shall be the name of model affixed with -L and size shall not be larger than 512*512, in tga or jpg format;

D. Naming rules: all maps shall be affixed correspondingly. Details are as follows: diffuse reflection map: -d; normal map: -n; specular map: -g; height map: -h;

E. When using unity transfer tool to processing normal map (name affixed with -n), Texture Type should be Normal map and the bumpiness value 0.02;

VII. Introducing the model upload background page to U3D, after the model is created, selecting the model to be exported for uploading; opening the upload page and selecting the model type (space model or object model), calling up corresponding upload options (the uploading page for the space model or the object model); after selecting well the uploading options, Prefabs file will be automatically generated from the model, then resetting all Transform parameters, and uploading the resource file named after the model name; as for the object model, capturing the model preview window of the Prefabs file from the angle relative to the central axis of xyz axis and then uploading, the background color of the preview window is white; capturing angle can be set by hand; the u3D export cannot appear special marks other than underscores and bars, like points, spaces, slashes (/ and \), etc.; single object can be added or deleted under the condition of not impacting on the collision of other objects; the scene and project files are automatically saved.

What is claimed is:

1. An interactive implementation method for mobile terminal display of 3D model, is characterized by the following steps:
I. Acquiring 3D model data from the data center, then optimizing the 3D model for reduction and putting the model category into the designated folder according to the model type;
II. Checking if the current environment is correct. If not correct, setting the environment;
III. Importing into different layer areas according to different categories of 3D models;
IV. Creating a Point Light for each area, and naming the Point Light by which space to enter;
V. Conducting material adaptation, firstly creating a [material library] and loading the [material library] to the project file; the Material in the imported FBX file adapts the shader and related parameters used by the Material with same name in the [material library]. Normal map for the 3D model is generated and put into the normal map channel;
VI. Determining the mapping specification and mapping the 3D model in the import file;
VII. Introducing the model upload background page to U3D, after the model is created, selecting the 3D model to be exported for mapping. opening the upload page and selecting the upload type, calling up all appropriate upload options, generating Prefabs file from the 3D model and then uploading.

2. An interactive implementation method for mobile terminal display of 3D model of claim 1,which is characterized by:
I. Acquiring the data of the 3D model from the data center using the Unity3D program, calling PolygonCruncherSDK, using face reduction optimization data to optimize the 3D model. After processing, put the 3D model into the designated folder according to the 3D model category;
II. Enabling Lnity3D to check if the current environment is correct. If not correct, make the following settings;
a. Modifying the default SkyBox to WispySkybox and Ambient Source to Color. Setting the Ambient Color parameter to RGB=5B5B5B, canceling the automatic baking;
b. The Bundle Identifier field in PlayerSettings is automatically set. Modifying Device Filter to ARMv7;
c. Setting Rendering Path to Forward mode;
d. Layers settings:
User Layer 8: Light, User Layer 9: Player, User Layer 10: Floor, User Layer 11: Tianhua, User Layer 12: Baijian, User Layer 20: NGUI, User Layer 21: Cube, User Layer 22: NewModel, User Layer 23: OPC, User Layer 24: door, User Layer 25: MovieTV, User Layer 26: Ditan;
e. Tags settings:
Tag 0: ding, Tag 1: che, Tag 2: pengzhuang, Tag 3: jiaohu, Tag 4: deng, Tag 5: diaodeng, Tag 6: dianti, Tag 7: diantianniu, Tag 8: damen, Tag 9: Terrain, Tag 10: TV;
f. QualitySettings is set to Fantastic and Pixel Light Count is set to 4, Anisotropic Texture is set to Forced On;
III. After importing the space model, putting the group chuang, group men , group chufang, dimian combination Tijiaoxian meshc in the Light layer; placing the object model in the Player layer (except ditan, diaodeng); Adding a Tag ding for group tianhua and ZGZ_01_noc; selecting Reflection Probe Static option in Static options for all objects; changing MaterialNaming to Model Name+Models Material;
IV. Creating a Point Light for each area, 2.2 meters above the ground. Selecting Important option of the Render Mode and Light, Player, baijian, ditan layers of the Culling Mask;
g. Point Light naming: the light source that has an influence on the main space shall be summarized into the main space naming; Such as: kt01-01, kt01-02, kt01-03, kt01-04, kt01-05, kt01-06; zws01-01, zws01-02; cws01-01, cws01-02;
h. Creating a Reflection Probe under the Point Light sublevel of each area and positioning the Reflection Probe to zero; Reflection settings: Type is Realtime; Refresh Mode is Via scripting; Time Slicing is No time slicing; selecting Box Projection; Size and Probe Origin settings shall be slightly larger than the size of the area in which they are located; The Resolution under Cubemap Capture settings is 256, and the rest are default;
i. All the child nodes under menzuOO1, menzu002, menzu003, etc. are added with empty objects and named according to which space to enter;
V. Material Adaption
The adapting method of material map for the object model is as follows:
Creating a [material library] by the shader script and common Material index and loading to project file; the Material in the imported FBX file adapts the shader and related index used by the Material with same name in the [material library] and at the same time maintains the Material's own diffuse reflection color and map and providing option for whether to generating normal map. The normal map will be automatically generated by the diffuse reflection map and will be put into the normal map channel after being generated;
The adapting method of material map for the space model is as follows:
j. after importing the model, the wall space model qiangmian_, tianhua_ will seeking for the light map corresponding to the name of the model by the shader of Legacy Shaders/Lightmapped/Bumped Diffuse and the Texture of Lightmap (RGB). For example, tianhua_01 will find the light map of tianhua_01-L.tga; the RGB value of Main Color is 255.225.225;
k. other material will adapt to the corresponding Material according to the object model method;
VI. Determining the mapping specification and conducting the mapping
A. The size of all the maps shall be adjusted to 128*128, 256*256, 512*512 according to the demanded size, no more thank 1024*1024; map of small object shall not be larger thank 256*256, tiled map shall be no larger than 512*512 and large-size map without being tiled shall be no larger than 1024*1024;
B. Size of maps of material in same category or of same specification or exchangeable shall be unified to 512*512;
C. Name of light map shall be the name of model affixed with -L and size shall not be larger than 512*512, in tga or jpg format;
D. Naming rules: all maps shall be affixed correspondingly. Details are as follows: diffuse reflection map: -d; normal map: -n; specular map: -g; height map: -h;
E. When using unity transfer tool to processing normal map (name affixed with -n), Texture Type should be Normal map and the bumpiness value 0.02;
VII. Introducing the model upload background page to U3D, after the model is created, selecting the model to be exported for uploading; opening the upload page and selecting the model type, calling up corresponding upload options; after selecting well the uploading options, Prefabs file will be automatically generated from the 3D model, then resetting all Transform parameters, and uploading the resource file named after the model name; as for the object model, capturing the model preview window of the Prefabs file from the angle relative to the central axis of xyz axis and then uploading. Changing the background color of the preview window white; the scene and project files are automatically saved.
